(19) United States
(12) Patent Application Publication
(10) Pub. No.: US 2009/0037556 A1
(43) Pub. Date: Feb. 5, 2009

(54) HTTP SERVICE DISCOVERY DEVICE

(75) Inventors: Heikki Kokkinen, Helsinki (FI); Seamus Moloney, Riihimaki (FI)

Correspondence Address: FOLEY & LARDNER LLP, P.O. BOX 80278, SAN DIEGO, CA, 92138-0278, US

(73) Assignees: NOKIA CORPORATION, Espoo (FI); NOKIA, INC, Irving, TX (US)

(21) Appl. No.: 10/575,152

(22) PCT Filed: Feb. 22, 2006
(86) PCT No.: PCT/IB2006/000362

§ 371 Date: Oct. 10, 2008

Related U.S. Application Data
(60) Provisional application No. 60/655,156, filed on Feb. 22, 2005.

(51) Int. Cl. G06F 15/16

(52) U.S. Cl. 709/217

(57) ABSTRACT

A system and method for using a service discovery device to enable communication between devices within a home network and a remote device. An IP address is provided to each device located within the home network. After the service discovery device makes at least one HTTP request to each of the IP addresses, the service discovery device receives information from a HTML page on each of the devices. A web page is then generated that contains the received information. The generated web page is accessible from the remote device, and the generated web page includes a list of links to device web pages for each of the devices located within the home network.

### FIELD OF THE INVENTION

The present invention relates generally to the discovery of various devices and services. More particularly, the present invention relates to the discovery of devices and services within home networks.

### BACKGROUND OF THE INVENTION

There are a number of computer network-related service discovery techniques that can be used for a home network, but they are usually not compatible with current devices such as existing personal computer browsers and mobile device browsers. It is currently believed that the most cost efficient manner for controlling other devices at home over a home network, such as a through a wireless local area network (WLAN) connection or an Ethernet connection, is to interface to those devices using hypertext markup language (HTML) pages. Home consumer devices typically have very low cost margins, and therefore there is strong pressure to save costs wherever possible. In this situation, the consumer electronics manufacturers first implement web-server based control of the devices.

In implementing such a system as discussed above, there are currently two significant issues. First, when devices have their own web pages, the user needs to know the internet protocol (IP) address or the uniform resource locator (URL) of the device. Second, there are currently a number of different service discovery protocols, including Universal Plug and Play (UPNP), service location protocol (SLP) and Juxtapose (JXTA), but each service discovery protocol requires a specific protocol to be implemented both in the terminal and in the home devices.

Conventionally, general service discovery protocols such as UPNP, SLP, and JXTA, service the discovery of web services. Search engines, such as Google, also have a similar type of functionality. However, a search engine, when retrieving information, will provide the links of unavailable services as well as available services. In other words, even if a device is off at a given moment, the link to the device will still be returned by the search engine.

### SUMMARY OF THE INVENTION

The present invention provides for a hypertext transfer protocol (HTTP) service discovery device (HSDD). This device provides for the discovery of HTTP services. The HSDD of the present invention also enables a user to remotely access and control devices within a home network. According to the present invention, devices within the home network have www-pages, i.e., home computers and personal video recorders which are running web servers. These pages are accessible from inside the home network or by using a secure remote access-based system running on IP Security (IPSEC) or a secure sockets layer (SSL) virtual private network (VPN). In order to access a specific device, the user must know the domain name system (DNS) name or the IP address of that device. The present invention enables the discovery of the devices of any normal web server with any web browser by utilising the HSDD.

The present invention provides for a number of benefits over conventional systems. The present invention provides a more cost efficient way to implement home network connectivity to consumer electronics, as it is already supported by current implementations.

These and other objects, advantages and features of the invention, together with the organization and manner of operation thereof, will become apparent from the following detailed description when taken in conjunction with the accompanying drawings, wherein like elements have like numerals throughout the several drawings described-below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a representation of a home network and its interaction with a remote device according to one embodiment of the present invention;

FIG. 5 is a flow chart showing the steps involved in one embodiment of the present invention;

FIG. 6 is a depiction of a sample service guide page according to one embodiment of the present invention; and

FIG. 7 is a depiction of a sample page for one home network device according to one embodiment of the present invention.

### DETAILED DESCRIPTION OF THE PREFERRED EMBODIMENTS

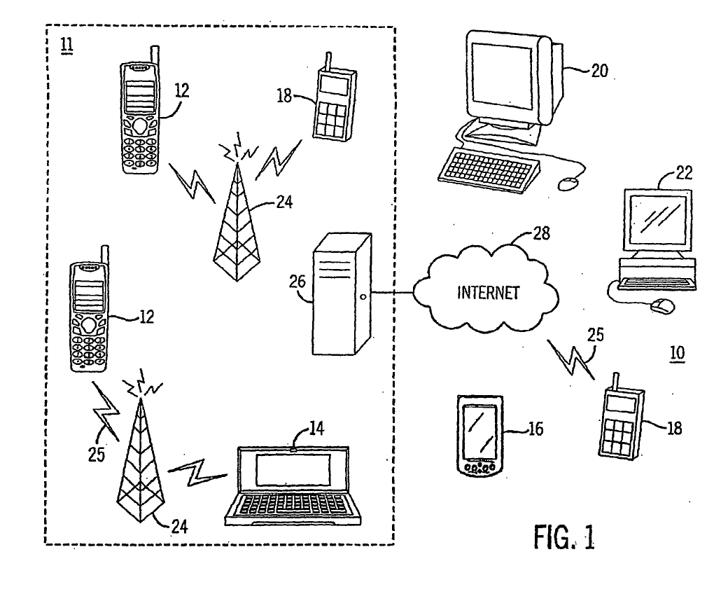

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types. A communication device may communicate using various media including, but not limited to, radio, infrared, laser, cable connection, and the like.

The communication devices may communicate using various transmission technologies including; but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

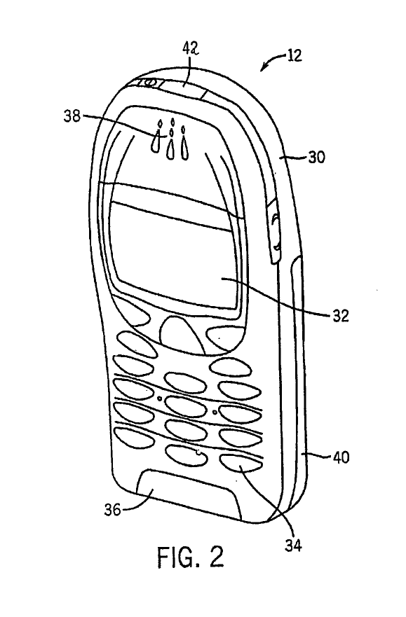

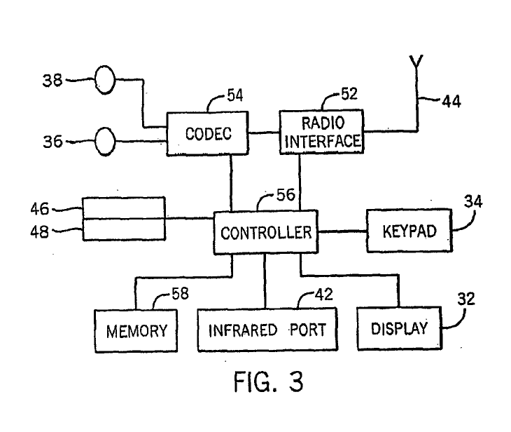

FIGS. 2 and 3 show one representative mobile telephone 12 within which the present invention may be implemented. It should; be understood, however, that the present invention is not intended to be limited to one particular type of mobile telephone 12 or other electronic device. For example, the present invention can be incorporated into the N-Gage discussed above. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

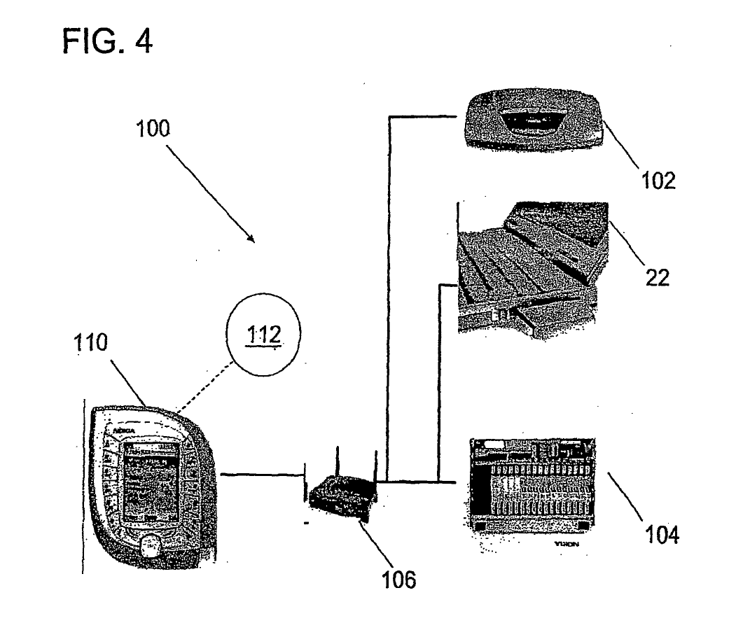

FIG. 4 shows a representation of a simplified home network 100. The present invention provides for a HTTP service discovery device, or HSDD, which provides discovery of HTTP services. Typically, a user has a number of devices within the home network 100, with the various devices including www-pages. The devices may include, for example, a notebook computer 22, a personal video recorder 102, and other devices which run web servers. Virtually any other type of device that is compatible with the home network 100 can also be included. The home network 100 also includes a home control center 104, also sometimes referred to as a control personal computer, and an access point 106 through which a user can communicate with the various devices through a browser 108 on a remote device 110. In FIG. 4, a portion of a mobile telephone 12 is shown as the remote device 110, although a wide variety of devices can be used for such communication.

The respective www pages are accessible from inside the home network 100 through a WLAN or Ethernet segment, or by using secure remote access based systems such as IPSEC or SSL VPN. In order to access a specific device, the user must know the DNS name or IP address of that device. The present invention enables the discovery of the devices of any normal web server with any normal web browser by utilizing the HSDD, which is depicted at 112 in FIG. 4.

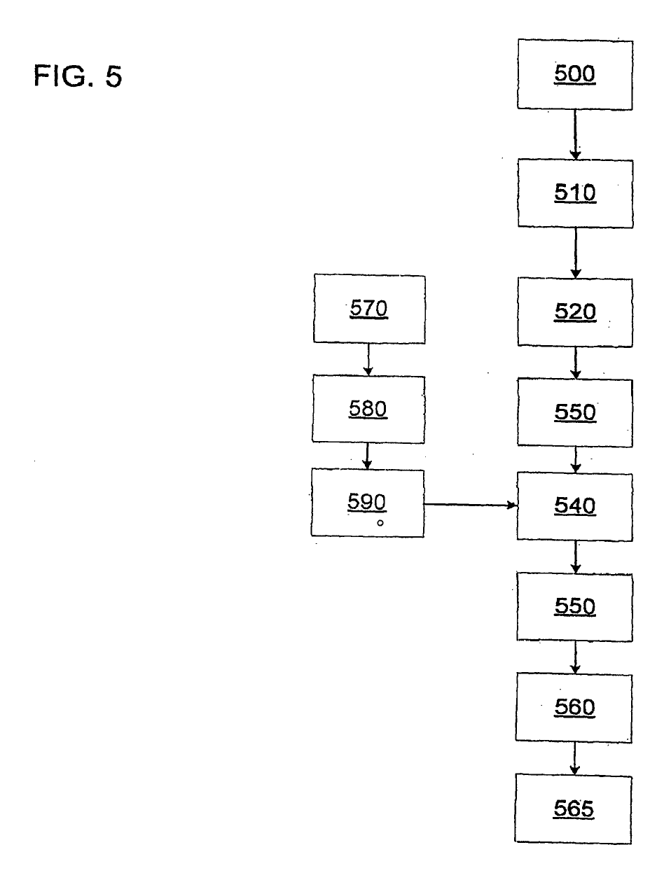

In one embodiment of the invention, the implementation of the present invention is carried out according to the flow chart of FIG. 5. In this particular implementation, the HSDD 112 is located in the access point 106 for the home network 100. It is also possible for the HSDD 112 to be located in other devices or to be a stand-along device. It should also be noted that the HSDD may be incorporated into a device with circuitry such as that depicted in FIG. 3. The access point 106 serves as the gateway between the external network, such as the Internet 28, and the home network 100. At step 500, the HSDD 112 provides private IP addresses to the various home network devices with dynamic host configuration protocol (DHCP) and provides Network Address Translation (NAT) services between the external network and the home network 100. When the HSDD 112 is located in the access point 106, it has access to the NAT addresses of all the client devices within the home network 100. Therefore, the HSDD 112 has the knowledge of all devices and their IP addressed within the home network 100.

At step 510, the HSDD 112 makes a series of HTTP requests to the IP addresses of the devices in the home network 100. At step 520, the HSDD 112 parses the title text or similar information from the main HTML page of each device (i.e. the index.HTML page). At step 530, the HSDD 112 records this information, as well as the IP address or DNS name of the device in the form of a URL.

When all of the devices in the home network 100 have been polled for this information, the HSDD 112 creates a web page at step 540, referred to herein as a service guide page, containing all of the information that was gathered. The service guide page is stored locally in the HSDD 112. At step 550, a user accesses the service guide page through his or her remote device 110 with a predetermined URL name such as “request.myhome.net.” The service guide page includes a list of names for the devices within the home network 100. When a user selects a name from the list, as represented at step 560, the remote device 110 will display a main web page for that specific device. At step 565, the user can then manipulate the main web page (e.g., by actuating individual links) in order to remotely control the respective device within the home network 100. This can be accomplished, for example, by embedding JavaScript in the main web page.

In one embodiment of the invention, the HSDD 112 may also utilize the knowledge of the media access control (MAC) addresses in the Local Area Network segment, as this information is available within the particular gateway device. This feature allows the HSDD 112 to build a clear picture of which devices were available in the network at any given time, without the need for constant polling. For example, when a home network device is turned off, represented at step 570, this event is noticed at the gateway device at the network level. The HSDD 112 therefore can be informed of this event by the networking software at step 580, and this information can be used to recreate and/or otherwise modify the service guide page, represented at step 590. A similar situation can occur whenever a new device enters the home network 100, or when other activities occur.

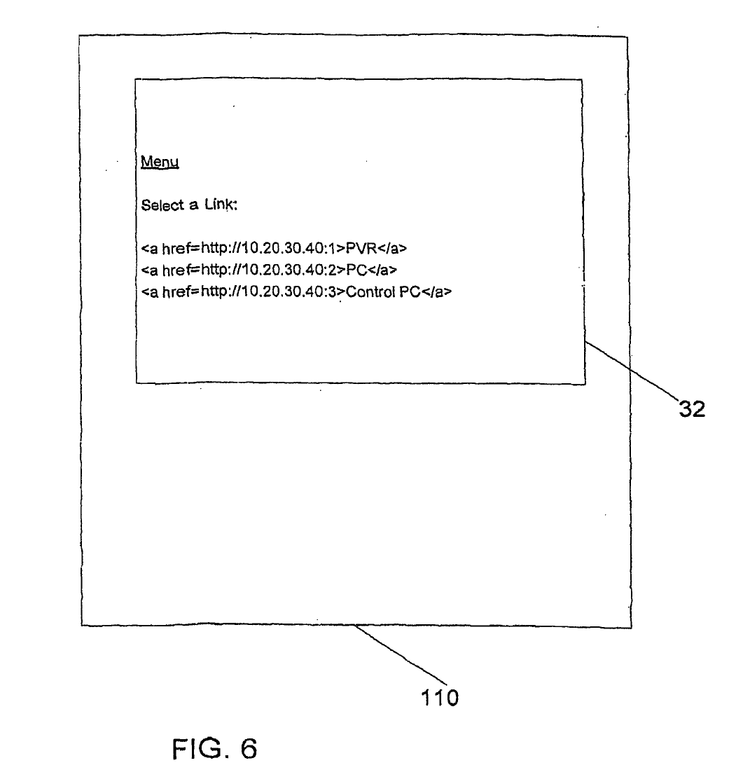

The following is one depiction of the security and implementation of one particular embodiment of the present invention. In a home network 100 of the type depicted in FIG. 4, the access point 106 has a public IP address of 10.20.30.40. The access point 106 has a NAT and DHCP server that gives an address of 192.168.1.xxx. The IP addresses given to the various home network devices are 198.168.1.1 for the personal video recorder 102; 192.168.1.2 for the notebook computer 22, and 192.168.1.3 for the home control center 104. Any connection that comes to the 10.20.30.40 IP address must be authenticated with transport layer security (TLS). If the connection is not authenticated, then the access point 106 discards the respective packets of information. The access point 106 has port forwarding, so that 10.20.30.40:1 is forwarded to 192.168.1.1:80, 10.20.30.40:2 is forwarded to 192.168.1.2:80, and 10.20.30.40:3 is forwarded to 192.168.1.3:80. When the service guide page is displayed, the following links are shown, as depicted in FIG. 6:

<a href-http://10.20.30.40: 1>PVR</a>
<a href=http://110.20.30.40:2>PC</a>
<a href=http://10.20.30.40:3>Control PC</a>

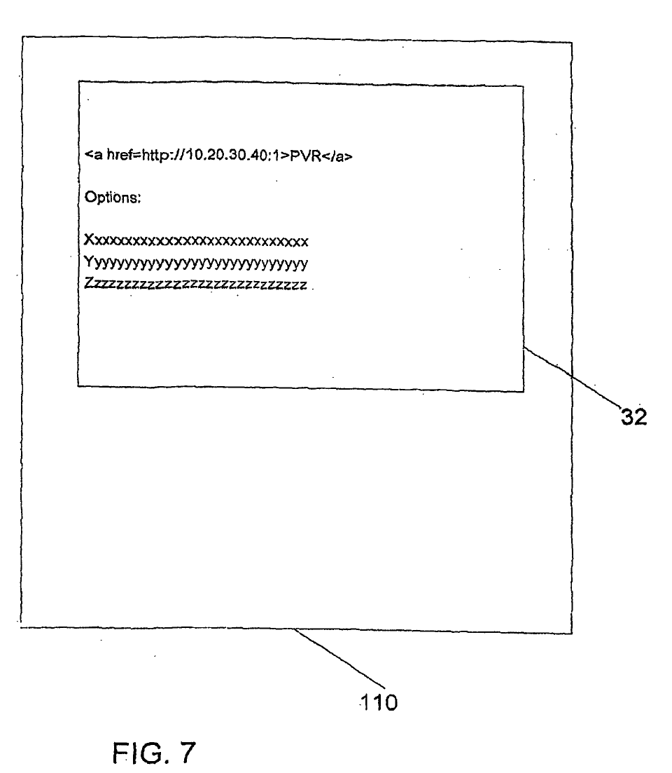

When a user selects <a href-http://10.20.30.40:1>PVR</a>, a new page appears on the remote device 10, as depicted in FIG. 7.

Most home networking technologies support events where devices report their state to any other networked device which has registered an interest. An HSDD of the present invention can support this feature by polling the networked devices and updating the service guide as necessary.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein and in the claims is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of using a service discovery device to control devices within a home network from a remote device, comprising:
providing an IP address to each device located within the home network;
making at least one HTTP request to each of the IP addresses;
receiving information from a HTML page on each of the devices; and
generating a web page containing the received information,
wherein the web page is accessible from the remote device in response to a request from the remote device to the service discovery device, and wherein the generated web page includes a list of links to device web pages for each of the devices located within the home network, the list of links being actuable from the remote device, enabling a user to control each of the devices.

2. The method of claim 1, further comprising recording the received information on the service discovery device.

3. The method of claim 1, further comprising, upon one of the links being actuated on the remote device, generating a device web page corresponding to the actuated link, wherein the device web page is accessible from the remote device, and wherein actuation of content on the device web page results in manipulation of the respective device.

4. The method of claim 1, further comprising:
receiving a MAC address for each of the devices within the home network; and
using the received MAC addresses to update the list of links on the web page when a change occurs regarding the devices within the home network.

5. The method of claim 4, wherein the change includes the addition of a new device to the home network.

6. The method of claim 4, wherein the change includes the removal of a device from the home network.

7. A computer program product for using a service discovery device to enable communication between devices within a home network and a remote device, comprising:
computer code for providing IP address to each device located within the home network;
computer code for malting at least one HTTP request to each of the IP addresses;
computer code for receiving information from a HTML page on each of the devices; and
computer code for generating a web page containing the received information,
wherein the web page is accessible from the remote device in response to a request from the remote device to the service discovery device, and wherein the generated web page includes a list of links to device web pages for each of the devices located within the home network, the list of links being actuable from the remote device to enable a user to control each of the devices.

8. The computer program product of claim 7, further comprising computer code for recording the received information on the service discovery device.

9. The computer program product of claim 7, further comprising computer code for, upon one of the links being actuated on the remote device, generating a device web page corresponding to the actuated link, wherein the device web page is accessible from the remote device, and wherein actuation of content on the device web page results in a corresponding manipulation of the respective device.

10. The computer program product of claim 7, further comprising:
computer code for receiving a MAC address for each of the devices within the home network; and
computer code for using the received MAC addresses to update the list of links on the web page when a change occurs regarding the devices within the home network.

11. The computer program product of claim 10, wherein the change includes the addition of a new device to the home network.

12. The computer program product of claim 10, wherein the change includes the removal of a device from the home network.

13. An electronic device for enabling communication between devices within a home network and a remote device, comprising:
a processor for processing information; and
a memory unit operatively connected to the processor, the memory unit including:
computer code for providing an IP address to each device located within the home network;
computer code for making at least one HTTP request to each of the IP addresses;
computer code for receiving information from a HTML page on each of the devices; and
computer code for generating a web page containing the received information,
wherein the web page is accessible from the remote device in response to a request from the remote device to a service discovery device, and wherein the generated web page includes a list of links to device web pages for each of the devices located within the home network, the list of links being actuable from the remote device to enable a user to control each of the devices.

14. The electronic device of claim 13, wherein the memory unit further comprises computer code for recording the received information on the service discovery device.

15. The electronic device of claim 13, wherein the memory unit further comprises computer code for, upon one of the links being actuated on the remote device, generating a device web page corresponding to the actuated link, wherein the device web page is accessible from the remote device, and wherein actuation of content on the device web page results in a corresponding manipulation of the respective device.

16. The electronic device of claim 13, wherein the memory unit further comprises:
computer code for receiving a MAC address for each of the devices within the home network; and
computer code for using the received MAC addresses to update the list of links on the web page when a change occurs regarding the devices within the home network.

17. A system for enabling communication between a remote device and at least one home network device, comprising:
a remote electronic device;
a home network including at least one home network device and a service discovery device, the service discovery device including:
computer code for providing an IP address to each of the at least one home network device located within the home network;
computer code for making at least one HTTP request to each IP address;
computer code for receiving information from a HTML page on each of the at least one device; and
computer code for generating a web page containing the received information,
wherein the web page is accessible from the remote electronic device in response to a request from the remote device to the service discovery device, and wherein the generated web page includes a list of links to device web pages for each of the at least one device located within the home network, the list of links being actuable from the remote device to enable a user to control each of the devices.

18. The system of claim 17, wherein the service discovery device includes computer code for, upon one of the links being actuated on the remote device, generating a device web page corresponding to the actuated link, wherein the device web page is accessible from the remote device, and wherein actuation of content on the device web page results in a corresponding manipulation of the respective device.

19. It system of claim 17, wherein the service discovery device includes:
computer code for receiving a MAC address for each of the at least one home network device; and
computer code for using the received MAC addresses to update the list of links on the web page when a change occurs regarding the at least one home network device.

20. The system of claim 17, wherein the service discovery device is located within an access point, the access point being in communication with both the remote device and the at least one home network device.
